(19) United States
(12) Patent Application Publication
(10) Pub. No.: US 2025/0208576 A1
(43) Pub. Date: Jun. 26, 2025

(54) HOROLOGICAL MOVEMENT COMPRISING A RIGID MOBILE ELEMENT COUPLED TO A RESILIENT ELEMENT AND METHOD FOR COUPLING THESE TWO ELEMENTS

(71) Applicant: ETA SA Manufacture Horlogère Suisse, Grenchen (CH)

(72) Inventors: Théo PENNINO, Nidau (CH); Stéphane BACHMANN, Büren an der Aare (CH)

(73) Assignee: ETA SA Manufacture Horlogère Suisse, Grenchen (CH)

(21) Appl. No.: 18/942,985

(22) Filed: Nov. 11, 2024

(30) Foreign Application Priority Data
Dec. 21, 2023 (EP) 23219470.4

(51) Int. Cl. G04B 19/253

(52) U.S. Cl. CPC G04B 19/25353

(57) ABSTRACT

A method and device for coupling a rigid element with a spring when assembling or mounting a horological device includes the steps of rigidly attaching the first end of the spring to a support and of positioning the support and the rigid element in an initial relative position in which a coupling member, carried by the spring at its second end, is located on one side of a stressing ramp which is opposite a specific recess in the rigid element and from which the rigid element and the support can undergo a relative movement (MR) in a first direction (D1). A relative movement is applied between the support and the rigid element in the first direction so that the coupling member comes to bear against the stressing ramp and then follows this stressing ramp, which is configured to thus move the coupling member towards the axis of rotation by stressing the spring. The relative movement is continued until the coupling member penetrates at least partially into the specific recess.

### TECHNICAL FIELD OF THE INVENTION

The present invention relates to a horological movement incorporating a device comprising a rigid element and a resilient element which are coupled together.

In particular, the device is a mechanism for driving an indicator in jumps. The rigid element comprises a driving finger for driving the jumping indicator. The resilient element is a spring comprising a coil between its first end and its second end, the first end being fixed to a wheel platform for rotation therewith and the second end carrying a coupling member, which is inserted at least partially into a recess in the rigid element.

The invention further relates to a method for coupling a rigid element with a resilient element when assembling a mechanical device or mounting the latter in a horological movement, in particular a drive mechanism for a jumping indicator.

### TECHNOLOGICAL BACKGROUND

Patent document EP 3828644 describes a mechanism for driving a semi-instantaneous jumping indicator comprising a drum-finger and a spring arranged in this drum and coupled thereto, the first end of the spring being fixed to a wheel platform for rotation therewith, which wheel platform drives this first end, and the second end carrying a coupling member partially inserted, movably and with substantial play, in a specific recess, i.e. a recess which is arranged for this coupling member and intended solely for this coupling member, and made in the drum-finger.

The mechanism disclosed in the patent document EP 3828644 presents various technical problems. Firstly, according to the figures, the coupling member of the spring is arranged in a shallow recess from which this member can easily emerge. More specifically, the two lateral surfaces of the recess are parallel in a radial direction passing through the middle of the recess, and the coupling member has two radial flanks. The angular width of the coupling member is intended to be significantly less than that of the recess, in particular to allow this member to penetrate easily into the recess. Thus, a relatively small impact can easily result in the coupling member coming out of its recess. If this is the case, either when the spring is loaded with the finger bearing against a tooth of the date ring, or before loading this spring, which then typically exhibits slight expansion due to the friction exerted on the drum, the coupling member exits a priori from the side of the finger radial driving flank. In such a situation, the lateral wall of the drum exerts a radial force on the coupling member such that the latter is subjected to a frictional force on this lateral wall.

If the coupling element comes out of the recess when the spring bearing against a tooth of the date ring is loaded, either it then slides along the inner lateral surface and the date jump will not occur until at least the drive wheel has made one revolution and the coupling element re-enters its recess (the best case scenario, which nonetheless results in the loss of a correct date display, which has missed a daily jump), or the frictional force is sufficient for the spring to expand again, further increasing the frictional force, until its coil touches the lateral wall and a date jump takes place at an indeterminate time. In the above case, after the date jump, the spring will relax, driving the drum, and the coupling member will probably undergo some sudden angular displacement along the lateral wall. This situation will be repeated on at least several days, with the date incrementing at indeterminate and variable times. In any event, the date drive mechanism is no longer functional as soon as the coupling member is out of its recess, which event is highly probable for the mechanism shown in the patent document EP 3828644.

Secondly, the mechanism disclosed in the patent document EP 3828644 presents a significant problem as regards the assembly of this mechanism. As can be seen from the figures, the cylindrical interior space of the drum-finger is circular with the recess machined around the periphery of this circular, cylindrical, interior space. Since the coupling member must be partially inserted into the peripheral recess and remain therein during normal operation, a radial distance of this spring, from the centre of the rigid ring, to which the first end of the spring is attached, to the outer lateral surface of the coupling member, when the spring is unstressed (i.e. relaxed/at rest/in its neutral position), is greater than the radius of said circular, cylindrical, interior space. Such a configuration of the spring poses a major problem when assembling the mechanism, which is of small dimensions (the spring typically has a diameter of less than 4 mm). More specifically, if we consider one possible assembly method wherein the spring is in a relaxed state, the drum-finger and the spring must be arranged, when they are brought onto the wheel platform, with a relatively precise relative angular positioning in which the coupling member is substantially aligned with the recess of the drum-finger and inserted axially into this recess.

The relative angular positioning mentioned above is not obvious because the spring is very small. Moreover, this spring is not visible when the drum-finger is placed on the wheel platform to allow it to be assembled with a hub which has a shaft that is inserted into the oblong hole in the drum-finger, the hole in the rigid ring and the central hole in the wheel platform from the side of the drum-finger (FIG. 5 of the document). Specific technical means or delicate handling operations to be carried out by the watchmaker must be provided to allow such relative angular positioning. Moreover, the coupling member can easily come out of the recess as long as the shaft is not inserted into the hole in the rigid ring, this hole thus no longer being axially aligned with the oblong hole in the drum-finger, which makes assembly difficult because the coupling member has to be re-inserted into the recess. On leaving the recess, it is highly likely that the coupling member will be angularly displaced relative to the recess, such that the re-insertion thereof becomes random and uncertain.

If the coupling member is not aligned with the recess after the spring and the drum-finger have been fitted to the wheel platform, the hole in the rigid ring cannot be aligned with the hole in the wheel platform without stressing the spring. However, it is difficult to see how the spring could be stressed and kept stressed, before the shaft is inserted into the hole in the rigid ring, once the spring has been inserted into the interior space of the drum-finger and covered thereby.

### SUMMARY OF THE INVENTION

The technological background shows a need in the watchmaking field for a device, formed by a rigid element and a resilient element coupled by means of a coupling member which is carried by the resilient element and inserted at least partially into its specific recess in the rigid element, which device is configured so as to simplify the assembly or mounting thereof inside a horological movement in relation to the coupling of the rigid element with the resilient element, and further shows a need for a method for coupling the rigid element with the resilient element, during the assembly or mounting of such a device, which method is easy to implement.

To achieve this objective, the invention relates to a horological movement comprising a device formed by a support, a rigid element which is movable and a resilient element which is coupled to this rigid element, the resilient element comprising a first end which is arranged so as to move with the support, at least in a first direction, and a second end carrying a coupling member inserted at least partially in a specific recess made in the rigid element. The support, the rigid element and the resilient element are arranged in such a way that, when the device is formed, they can be pre-mounted in the horological movement or pre-assembled in an intermediate state wherein:—the first end of the resilient element is arranged so as to move with the support in the first direction;—the rigid element and the support with the resilient element have an initial relative position, from among a range of possible relative positions, in which the resilient element is relaxed; and—the coupling member is located outside of its specific recess. The rigid element comprises a stressing ramp provided for the resilient element and located close to said specific recess, the stressing ramp being arranged so that, at least when assembling or mounting the device inside the horological movement from said intermediate state, the coupling member can come to bear against the stressing ramp, by a guided relative movement between the rigid element and the support in the first direction, from said initial relative position and then follow this stressing ramp as it approaches its specific recess while the relative movement is continued with at least one non-zero component in the first direction, the stressing ramp being arranged so that, during this continuation of the relative movement, the coupling member is displaced relative to the support, at least one non-zero component of which lies in a second direction that is not parallel to the first direction, and the resilient element is thus stressed. The coupling member is configured so that, after following the stressing ramp as it approaches its specific recess, it can penetrate at least partially into this recess, while the resilient element undergoes at least partial relaxation, and ultimately occupy a functional coupling position in which it remains during any normal operation of the horological movement.

According to a particular alternative embodiment, the device is configured so that the resilient element is substantially relaxed, i.e. unstressed, once the coupling member is in the functional coupling position after the device has been assembled or mounted inside the horological movement.

According to a main embodiment, said first direction is an angular direction relative to an axis of rotation, defining a rotation about this axis, and said second direction is a radial direction, relative to said axis of rotation, which passes through a geometric centre of the coupling member.

According to a general alternative embodiment, said range of possible relative positions in said intermediate state extends over at least 20°.

According to an advantageous alternative embodiment, the range of possible relative positions in the intermediate state extends over at least 45°, preferably over at least 60°.

According to a particular embodiment of the main embodiment, the device is a mechanism for driving a jumping indicator, the resilient element being a spring comprising a coil between its first end and its second end, said support being a wheel platform which is rotatably mounted about said axis of rotation and which drives the first end of the spring, the rigid element comprising a driving finger arranged to drive the jumping indicator in a given drive direction.

According to an advantageous alternative embodiment, the stressing ramp is arranged so that, when the coupling member follows this stressing ramp as it approaches its specific recess, the coupling member is displaced radially towards the axis of rotation, and the coil of the spring is thus stressed.

The invention further relates to a method for coupling a rigid element with a resilient element when assembling or mounting a device intended to form a movement, wherein the resilient element comprises a first end, intended to be assembled with a support comprised in the device or the horological movement, and a second end carrying a coupling member intended to be assembled with the rigid element in order to couple the rigid element with the resilient element, the rigid element having a specific recess for the coupling member and a stressing ramp intended to guide the resilient element while stressing it, during the coupling method, and situated close to the specific recess. The coupling method comprises the following steps of:
Attaching the first end of the resilient element to the support so that it moves as one therewith in a first direction;
Positioning the support with the resilient element and the rigid element in an initial relative position, from among a range of possible relative positions, in which possible relative positions the resilient element is relaxed, in which initial relative position the stressing ramp is located between the coupling member and said specific recess of the rigid element and from which the rigid element and the support can undergo, at least during assembly or mounting of the device, a guided relative movement in the first direction; the resilient element with the coupling member and the rigid element being configured so that the stressing ramp crosses a geometric line passing through a contact point between the coupling member and the stressing ramp and parallel to the first direction;
   and then comprises the following coupling step of:
Applying a guided relative movement between the support and the rigid element in said first direction so that the coupling member comes to bear against the stressing ramp, the coupling member then following this stressing ramp while the relative movement is continued with at least one non-zero component in the first direction, the stressing ramp being configured so as to generate, during the continuation of the relative movement, a displacement of the coupling member relative to the support, having at least one non-zero component in a second direction that is not parallel to the first direction, while stressing the resilient element; the relative movement being continued until the coupling member penetrates at least partially into said specific recess, while the resilient element undergoes at least partial relaxation in the second direction, and ultimately occupies a functional coupling position in which it remains during any normal operation of the horological movement; the coupling member and its specific recess being configured to allow the coupling member to reach this functional coupling position, during said at least partial relaxation of the resilient element, after having followed the stressing ramp.

According to a particular implementation, the spring, the coupling member and the stressing ramp are arranged so that, during the coupling step, the coupling member slides, after following the stressing ramp, on an end zone of this stressing ramp, during said relative movement, before the coupling member reaches said functional coupling position in its specific recess.

According to an advantageous implementation of the method, the stressing ramp, the spring and the coupling member are arranged in such a way that, when the coupling member follows the stressing ramp as it approaches its specific recess, the coupling member rotates about itself, which encourages or allows subsequent penetration of this coupling member into its specific recess, so that the coupling member can reach the functional coupling position.

According to another advantageous implementation, the first direction is an angular direction relative to an axis of rotation, defining a rotation about this axis, and the second direction is a radial direction, relative to said axis of rotation, which passes through a geometric centre of the coupling member, which is thus radially displaced as it follows the stressing ramp as it approaches its specific recess.

In other embodiments of a horological movement according to the invention and other implementations of the method according to the invention, a guided relative movement between the support and the rigid element is intended to take place, until the coupling member comes into contact with the stressing ramp, which movement is not rotational. In other words, a first direction that is not an angular direction is provided, in particular a linear direction. More complex guided relative movements can optionally be implemented. It should be noted that, following the contact made between the coupling member and the stressing ramp, the continuation of the relative movement, during a second phase of the relative movement, to allow the coupling member to climb the stressing ramp can be a more complex relative movement than a linear movement or a rotation taking place, during the first phase of the relative movement, before the coupling member comes to bear against the stressing ramp, in particular when the rigid element is displaced in reaction to a pressure exerted by the coupling member on the stressing ramp.

In a general implementation, in which the rigid element is formed by a plate or is mounted rotatably on a plate, the method comprises, before the coupling step, an initial step in which a hub comprising a shaft and a head, the wheel platform, the spring provided at its first end with a central rigid part and the plate, respectively the plate with the rigid element mounted on this plate, are brought and positioned such that the wheel platform, the spring and the plate, respectively the rigid element, are in a relative position corresponding angularly to one said possible relative position with the spring located between the wheel platform and the plate, and the head located on a side opposite the spring relative to the plate; and such that the shaft, a first hole in the plate, a second hole in the wheel platform and a third hole defined by the central rigid part are aligned on said axis of rotation, the second hole having a smaller diameter than the first hole and the head being at least partially stacked on the plate; and then an assembly step which includes said rigid attachment step and in which the shaft is forcibly inserted into the second hole in the wheel platform, leaving the plate free to rotate about the shaft, with the head ultimately ensuring that this plate is held in the axial position.

### BRIEF DESCRIPTION OF THE FIGURES

The aims, advantages and features of the invention will be described in greater detail below with the aid of the accompanying drawings, which are given by way of non-limiting examples, in which:

FIG. 1 is a top view of a device for a horological movement according to a first embodiment of the invention;

FIG. 2 is an exploded, perspective view of the device shown in FIG. 1;

FIG. 3A to 3E show a first implementation of a coupling method, according to the invention, for coupling a rigid element with a resilient element during the assembly or mounting of a mechanical device intended to form a horological movement, in order to obtain, in this first implementation, the device according to the first embodiment;

FIG. 4A and 4B show two particular moments of a preferred operating mode of the mechanical device shown in FIG. 1, which mechanical device is incorporated in a horological movement, in which it forms a drive device for a date ring;

FIG. 5 is a top view of a device for a horological movement according to a second embodiment of the invention;

FIG. 6 is an exploded, perspective view of the device shown in FIG. 5;

FIG. 7A to 7F show a second implementation of a coupling method, according to the invention, for coupling a rigid element with a resilient element during the assembly or mounting of a device according to the invention intended to form a horological movement according to the second embodiment (it should be noted that the plate 11 is shown transparently);

FIG. 8A and 8B show two particular moments of a preferred operating mode of the mechanical device shown in FIG. 5, which mechanical device is incorporated in a horological movement, in which it forms a drive device for a date ring;

FIG. 9 shows the device according to the second embodiment in a possible pre-mounted state, which results from the mounting of this device during which a relative rotation between the lever and the support was excessive.

### DETAILED DESCRIPTION OF THE INVENTION

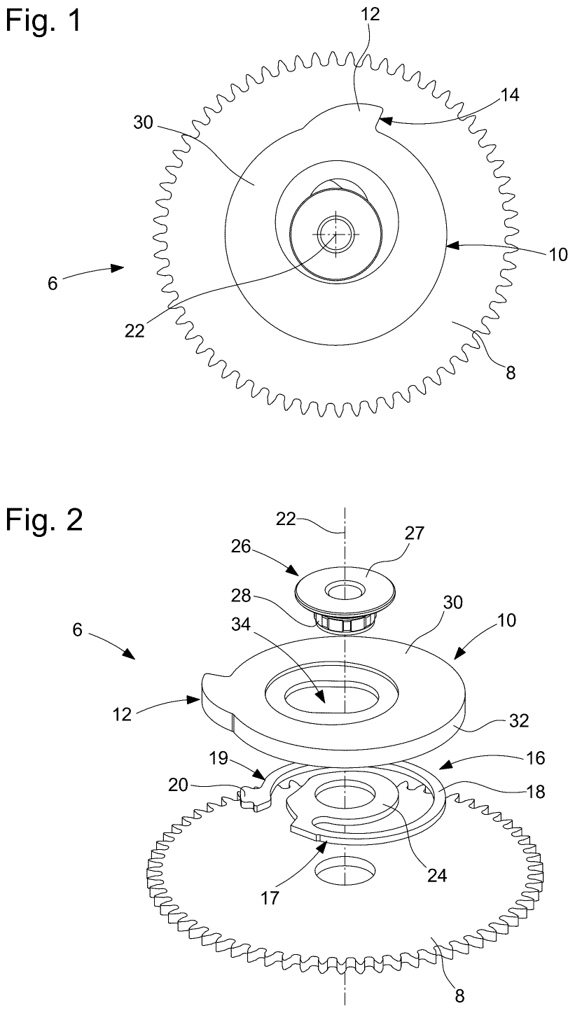

FIGS. 1 to 4B are used to describe a first embodiment of a horological movement 2 according to the invention, which horological movement incorporates a device for driving a jumping indicator, as well as to describe a first implementation of a method for coupling a rigid element with a resilient element during assembly or mounting of the device.

The device 6 forms a mechanism for driving a jumping indicator 4, in particular by semi-instantaneous jumps. This device 6 comprises a support formed by a wheel platform 8, a rigid element forming a drum-finger 10 and arranged above the wheel platform, and a resilient element formed by a spring 16. This spring comprises a first end 17, a coil 18 and a second end 19. The wheel platform 8 has an axis of rotation 22. The drum-finger 10 defines a driving finger 12 for driving the indicator 4, which in this case forms a date ring. This drum-finger has a drive flank 14 intended to come into contact with a tooth of a toothing 5 of the indicator in order to drive this indicator in jumps. The drum-finger can rotate relative to the wheel platform 8 and is guided rotatably about the axis of rotation 22 by a shaft 28, which has a hub 26 passing through an oblong hole 34 in the drum-finger. The first end 17 of the spring 16 is connected to a central rigid part 24 which is attached to the wheel platform 8 for rotation therewith. Preferably, the spring and the central part form one and the same part.

The drum-finger 10 is formed by a plate 30, which extends above the spring 16 and in which the oblong hole 34 is machined, and an axial wall 32 arranged at the edge of this plate and which slopes down towards the wheel platform 8, on which it can rest in one alternative embodiment. The drum-finger thus defines an interior space 9 in which the spring is arranged. A part of the axial wall and a part of the plate, which is stacked thereon, jointly form the driving finger 12, which advantageously has a height that extends at least from the underside of the spring to the upper surface of the plate 30. In an advantageous alternative embodiment, the wheel platform 8 and the central rigid part 24 are driven on the shaft 28 of the hub 26, which further comprises a head 27 which extends partially above the plate 30 so as to hold the drum-finger 10 in an axial position.

The axial wall 32 has, at the driving finger, a recess 36 which has a lateral opening on the side of the spring 16, i.e. on the side of the axis of rotation 22 of the device 6. The second end 19 of the spring is extended by a member 20 for coupling to the rigid element 10 (i.e. in this case the drum-finger), this coupling member 20 being configured so as to be able to penetrate at least partially into the recess 36, which is a specific recess for the coupling member, through the lateral opening and allow the spring to then be able to apply a driving force couple to the rigid element 10. In the alternative embodiment described, the coupling member 20 is rigid.

According to an advantageous alternative embodiment, the recess 36 has a lateral surface 54 oriented obliquely in the direction of rotation 56 of the wheel platform 8, in which direction the indicator is intended to be driven, relative to a radial direction passing through the centre of the lateral surface, and the coupling member 20 has a lateral flank 52, facing the lateral surface, which is also inclined obliquely in the same direction as the lateral surface and which bears at least partially against the lateral surface each time the spring 16 is loaded for driving the jumping indicator using the mechanism 6. The coupling member 20 has a nose 42, defining the lateral flank 52, which is configured to fit into a complementary shape of the recess 36 having substantially the same profile. This particular feature ensures that the coupling member is held precisely in a given drive position inside the recess as soon as the spring is tensioned during loading, the lateral surface exerting a reaction force on the nose 42 of the coupling member with a component directed outwards and thus towards the bottom of the specific recess 36. Thus, despite the contraction undergone by the spring 16, the nose 42 remains in a given driving position for which the radius of application of the driving force of the spring on the drum-finger 10 remains identical during loading of the spring and substantially at its maximum. This feature results in the force couple transmitted being at its maximum for a given spring driving force during loading.

According to a particular feature, the coupling member 20 has a rear heel intended to prevent rotation of the coupling member about itself, once inserted into its specific recess 36, in the direction of rotation 56 of the wheel platform (direction of rotation intended for driving the indicator). This rear heel is extended by a contact surface 46 which comes to bear against an angular stop 48 at the end of the loading of the spring 16, to then cause the indicator to jump. Preferably, the angular stop 48 is located between the first end 17 of the spring and the central rigid ring 24, in the angular extension of the coil 18 of the spring, and is defined by one and the same part forming the rigid ring and the spring.

Furthermore, in an advantageous alternative embodiment, the recess has a minimum dimension on the side of its opening which is slightly smaller than a maximum dimension of the coupling member perpendicular to the radial direction, relative to the central axis of the rigid ring coincident with the axis of rotation 22, with the spring in an angularly relaxed state. More typically, the coupling member and its specific recess are arranged in such a way that the coupling member cannot emerge from its specific recess by undergoing at least one translation relative to the rigid part, i.e. without undergoing at least one rotation about itself (rotation about its geometric centre about an axis parallel to the axis of rotation 22). To enter the specific recess through the lateral opening, the coupling member must thus rotate slightly about itself, about its geometric centre 21. This feature ensures that once the coupling member has been properly inserted into the specific recess and is thus in a functional coupling position, there is very little risk of it coming out of the specific recess, although this is not impossible in exceptional cases in the event of specific impacts. One advantageous alternative embodiment of the coupling method according to the invention produces a coupling with the slight rotation of the coupling member required for the alternative embodiment described here.

Once the coupling member 20 has been assembled to the drum-finger 10, without any external stresses and in particular without any impact, this coupling member normally remains coupled to the drum-finger 10 at all times, whatever the state of the device 6, i.e. in a non-angularly stressed state of the spring in periods when there is no interaction between the toothing 5 of the indicator 4 and the driving finger 12, in a state in which the spring works in contraction when it is loaded before the indicator jumps, when the indicator jumps, and also when the spring is slightly stressed in expansion, in particular when the wheel platform 8 is rotated in a direction opposite to the intended direction for driving the indicator 4, in order to correct the time in a counter-clockwise direction. In conclusion, during normal operation of the horological movement 2, the coupling member 20 remains coupled to the drum-finger as intended, i.e. in place in the specific recess 36, and thus integral with the drum-finger. Typically speaking, it is provided that, once the horological movement has been assembled and completed, the coupling member occupies a functional coupling position in which it remains during any normal operation of the horological movement. It should be noted that during normal operation, no impacts are expected to generate strong accelerations, and that the horological movement is typically subject to strong accelerations.

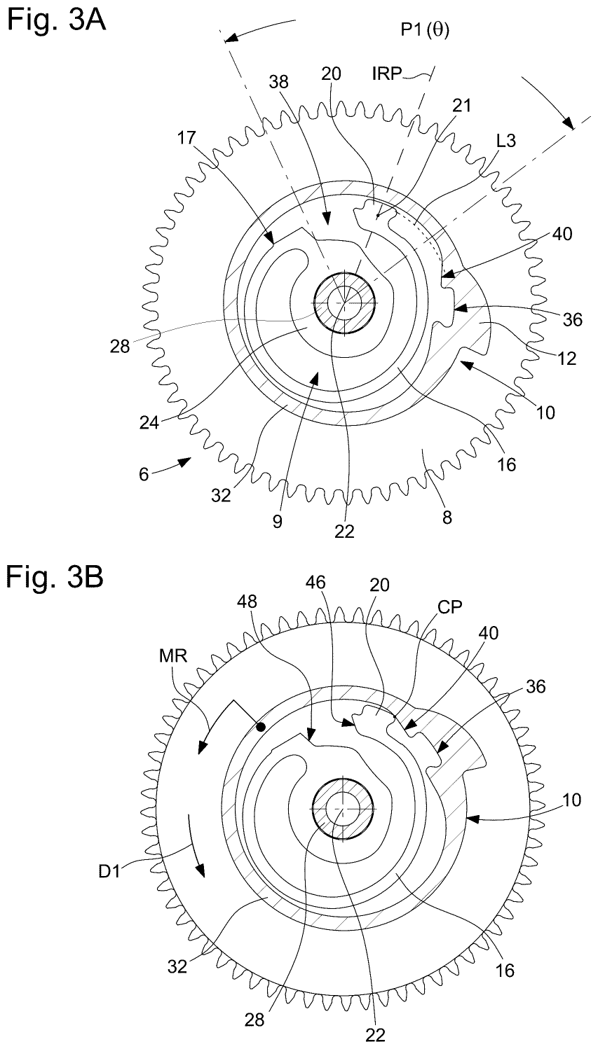

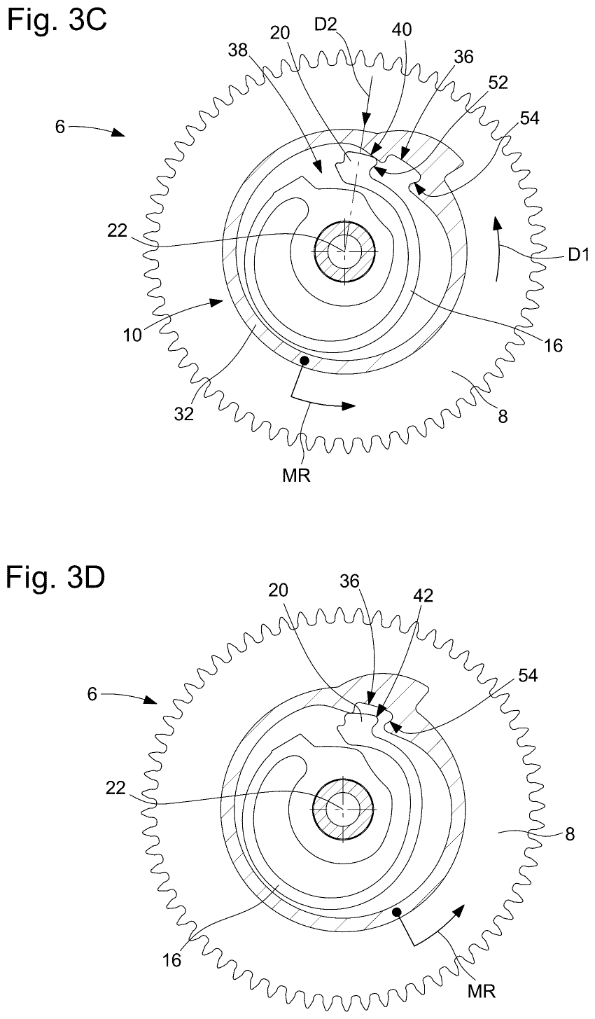

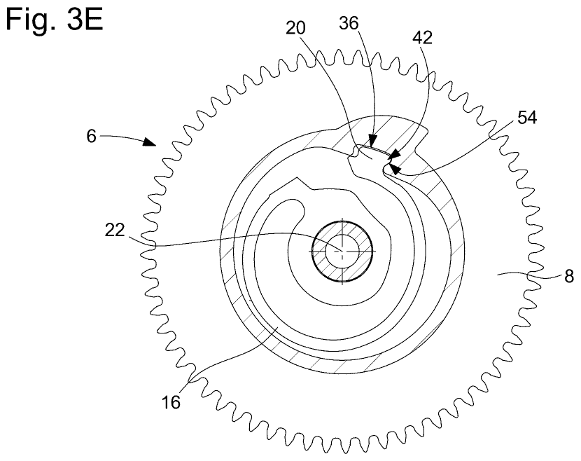

One general implementation of the method for coupling a rigid element with a resilient element during the assembly or mounting of a device intended to form a horological movement will be described below. Then, with reference to FIG. 3A to 3E, a first implementation of the coupling method according to the invention will be described.

Typically speaking, the method for coupling a rigid element with a resilient element, during the assembly or mounting of a device intended to form a horological movement, relates to a resilient element, in particular a spring which can have various shapes, which spring comprises a first end, intended to be assembled with a support, in particular a wheel platform, comprised in the device or the horological movement, and a second end carrying a coupling member, intended to be assembled with the rigid element in order to couple the rigid element with the resilient element. The rigid element, in particular a lever or a drum-finger which is arranged so as to be movable relative to the support and on which it is intended to exert a return force, has a specific recess for the coupling member and a stressing ramp located close to the specific recess and intended to guide the resilient element by momentarily stressing it during the coupling method.

According to a general implementation, the coupling method comprises the following steps of:
Attaching the first end of the resilient element to the support so that it moves as one therewith in a first direction;
Positioning the support with the resilient element and the rigid element in an initial relative position, from among a range of possible relative positions, in which possible relative positions the resilient element is relaxed, in which initial relative position the stressing ramp is located between the coupling member and said specific recess of the rigid element and from which the rigid element and the support can undergo, at least during assembly or mounting of the device, a guided relative movement in the first direction; the resilient element with the coupling member and the rigid element being configured so that the stressing ramp crosses a geometric direction passing through a contact point between the coupling member and the stressing ramp and parallel to the first direction;
   and then comprises the following coupling step of:
Applying a guided relative movement between the support and the rigid element in said first direction so that the coupling member comes to bear against the stressing ramp, the coupling member then following this stressing ramp while the relative movement is continued with at least one non-zero component in the first direction, the stressing ramp being configured so as to generate, during this continuation of the relative movement, a displacement of the coupling member relative to the support, having at least one non-zero component in a second direction that is not parallel to the first direction, while stressing the resilient element; the relative movement being continued until the coupling member penetrates at least partially into said specific recess, while the resilient element undergoes at least partial relaxation in the second direction, and ultimately occupies a functional coupling position in which the coupling member remains during any normal operation of the horological movement; the coupling member and the specific recess being configured to allow the coupling member to reach this functional coupling position, during said at least partial relaxation of the resilient element, after having followed the stressing ramp.

In the first implementation of such a method, said first direction is an angular direction D1 relative to the axis of rotation 22, defining a rotation about this axis, and said second direction is a radial direction D2, relative to the axis of rotation 22, which passes through a geometric centre 21 of the coupling member, which is thus radially displaced as it follows the stressing ramp 40 as it approaches its specific recess 36. The device is a mechanism 6 for driving a jumping indicator 4, the resilient element being a spring 16 comprising a coil 18 between its first end 17 and its second end 19. The support is a wheel platform 8 which drives the first end of the spring 16 and defines the axis of rotation 22. The rigid element 10 comprises a driving finger 12 for driving the jumping indicator in a given drive direction.

In the first implementation of the coupling method, which is a particular case of the general implementation, the aforementioned steps are described, with reference to FIG. 3A to 3E, as follows:
Attaching the first end 17 of the spring 16 to the wheel platform 8 for rotation therewith;
Positioning (FIG. 3A) the wheel platform 8 and the rigid element 10, forming in particular a drum-finger, in an initial relative position IRP, from among a range of possible relative angular positions P1(θ) for which the spring 16 is relaxed, the spring and the rigid element being arranged so that such a range of relative angular positions exists with the spring relaxed; the stressing ramp 40, in the initial relative position IRP, being situated between the coupling member 20 and the recess 36 of the rigid element 10; the rigid element 10 and the wheel platform 8 being capable of undergoing, during the assembly or mounting of the mechanism 6, from the initial relative position IRP, a guided relative movement MR in an angular direction D1 centred on the axis of rotation 22; the spring 16 with the coupling member 20 and the rigid element 10 being configured so that the stressing ramp 40 crosses a geometric line L3 passing through a contact point CP of the coupling member and defining a circle;
   and then comprises the following coupling step of:
Applying a guided relative movement MR between the wheel platform 8 and the rigid element in said angular direction D1 (FIG. 3B to 3E) such that the coupling member 20 comes to bear against the stressing ramp 40 (FIG. 3B) and then follows this stressing ramp (FIG. 3C), the coupling member then follows this stressing ramp while the relative movement is continued in the angular direction D1, the stressing ramp 40 being configured to generate, during the continuation of the relative movement, a displacement of the coupling member relative to the wheel platform, having at least one non-zero component in a radial direction D2, while stressing the spring 16; the relative movement being continued until the coupling member penetrates at least partially into its specific recess 36 (FIG. 3E), while the spring undergoes at least partial relaxation, preferably total relaxation in the radial direction, and this coupling member ultimately occupies a functional coupling position in which it remains during any normal operation of the horological movement; the coupling member 20 and the specific recess 36 being configured to allow the coupling member to reach the functional coupling position, during said relaxation of the resilient element, after having followed the stressing ramp 40.

It should be noted that the spring 16 is forced into contraction during the relative movement MR provided for coupling the spring 16 with the rigid element 10 via the specific recess 36 defined by this rigid element and the coupling member 20 carried by the second end 19 of the spring, this coupling member preferably being formed integrally in one piece with the spring and thus forming one and the same part with this spring. Advantageously, the central rigid ring 24 is also attached to the first end 17 of the spring so as to form one and the same part with this spring. Thus, as shown in the figures, the spring, the coupling member and the central rigid ring are formed by one and the same part. Moreover, the spring 16 and the rigid ring 24 are arranged so as to have, when the spring is relaxed, a free space 38 into which the coupling member 20 can penetrate when the spring is contracted. This is important for the coupling method, in the alternative embodiment shown, and also for the operation of the mechanism 6 when driving an indicator 4, in particular a date ring.

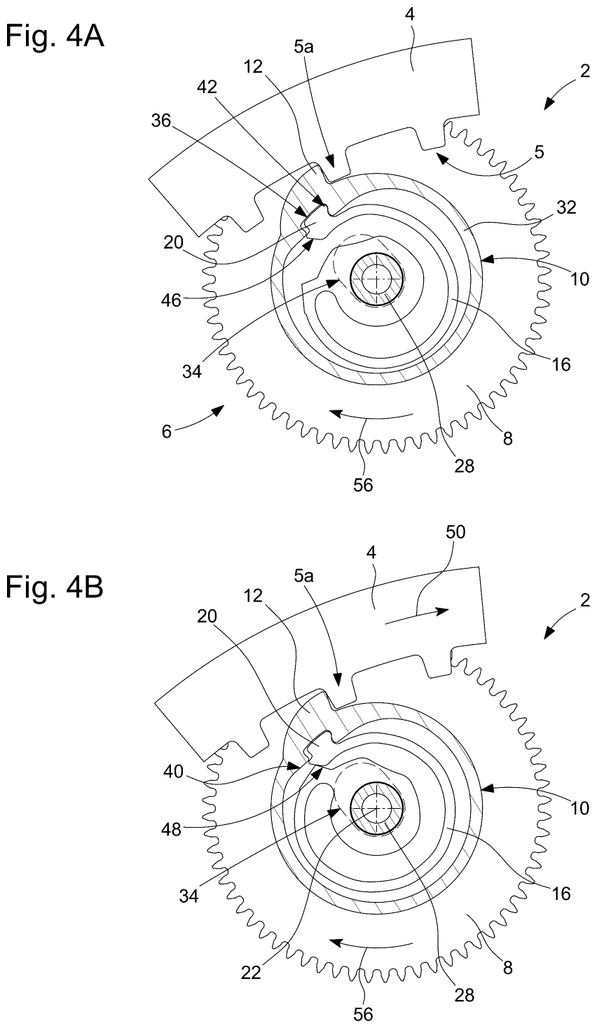

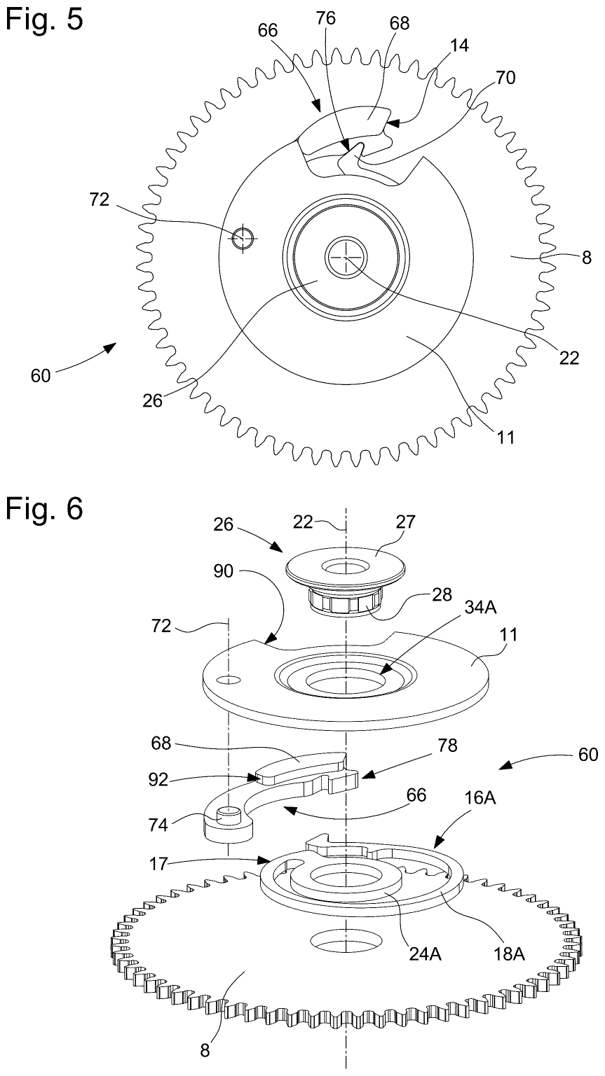

As shown in FIG. 4A and 4B (in which the oblong hole 34 of the plate 30 is shown as a dashed line), once the mechanism 6 has been assembled according to the coupling method described above, and this mechanism has been mounted in the horological movement 2 according to the invention, the wheel platform 8 is intended to be driven by the time display mechanism in the direction of rotation 56. Thus, the rigid element 10, forming a drum-finger comprising a driving finger 12, is driven rotatably by the wheel platform and, each day before midnight, the driving finger 12 comes to bear (FIG. 4A) against a lateral flank of a tooth 5a of a toothing 5 of the date ring. Then, during a first phase, the spring 16 is loaded by a contraction of its coil 18 until the contact surface 46 of the coupling member comes to bear against the angular stop 48 (FIG. 4B). Then, rapidly after this event, the jump of the date ring is triggered. In another alternative embodiment, the jump can be triggered before the contact surface 46 comes to bear against the angular stop 48, the latter thus forming a safety stop for the spring, so that it cannot be damaged.

In the first implementation of the method, the stressing ramp 40 is arranged upstream of the recess 36 relative to the direction of rotation 56 of the wheel platform 8 when the jumping indicator 4 is driven by the mechanism 6 in the given drive direction.

The particular shape of the coupling member 20, the arrangement of the spring 16 and the configuration of the stressing ramp 40 mean that, during the coupling step, the coupling member slides, after following the stressing ramp, over an end zone of this stressing ramp, during said guided relative movement MR, before the coupling member 20 at least partially penetrates into the specific recess 36 and occupies the functional coupling position.

According to an advantageous alternative implementation, the stressing ramp 40, the spring 16 and the coupling member 20 are arranged in such a way that, when the coupling member follows the stressing ramp as it approaches the specific recess 36, the coupling member rotates about itself, i.e. it rotates about its geometric centre 21, which encourages or, in a preferred alternative implementation, which allows subsequent penetration of this coupling member into its specific recess, so that the coupling member can reach the functional coupling position. As mentioned above, this alternative implementation is advantageous because it allows complementary shapes to be designed for the coupling member and the specific recess, so that, in practice, the coupling member no longer comes out of the specific recess in the event of an impact. The rotation of the coupling member about itself occurs, during the assembly of the spring to the rigid element defining the specific recess, by the relative rotational motion between the rigid element and the support (the drum-finger and the wheel platform) thanks to the stressing ramp 40 which stresses the spring 16 by way of a displacement, a main component whereof being radial, of the coupling member 20 towards the axis of rotation 22, generating the sufficient rotation of this member about itself to allow an orientation that enables it to be inserted into the specific recess 36. This is remarkable.

As can be seen in FIG. 3A, the range of possible relative positions P1(θ) of the spring 16 in a relaxed/unstressed state, placed in the interior space 9 of the drum-finger 10 during the assembly or mounting of the mechanism 6, in said intermediate state, extends over approximately 75°. This value corresponds to a preferred alternative embodiment, in which the range of possible relative positions extends over at least 60°. In a general alternative embodiment, the range of possible relative positions in the intermediate state extends over at least 20°, while in an advantageous alternative embodiment, this range extends over at least 45°. The relatively wide range of possible relative positions P1(θ) in the intermediate state, prior to the relative rotational motion for coupling, is a very advantageous benefit of the invention, as it is thus possible to bring the spring and the drum-finger (the rigid element) together without requiring precise initial positioning therebetween. Moreover, in the intermediate state, the spring is relaxed/unstressed, such that its supply and initial positioning in the axial position are easy and do not require either precise initial relative positioning, in particular to initially place the coupling member facing its specific recess, or the need to stress the spring in this intermediate state. The spring is then stressed by the stressing ramp during the guided relative movement MR provided and the coupling member is then inserted into its specific recess with at least partial relaxation of the spring, so that this member remains in the specific recess in the absence of external stresses. The end part of the stressing ramp defines an edge of the specific recess of the coupling member, the opposite edge of this specific recess advantageously being located at approximately the same radial distance from the axis of rotation 22.

In a particular alternative implementation of the coupling method according to the invention, the rigid element 10 is formed by a plate 30 or is mounted so as to be able to rotate on a plate (case related to the second embodiment which will be described below). The coupling method comprises, prior to the coupling step, an initial step in which the wheel platform 8, the spring 16 and the plate 30, in particular the drum-finger 10 which is formed in part by this plate 30 in the alternative embodiment shown, are brought and positioned in said initial relative position with the spring located between the wheel platform and the plate; and it then comprises an assembly step which includes said rigid attachment step and wherein the hub 26, comprising a shaft 28 and a head 27, is brought to the side of the plate and the shaft is inserted into a first hole 34 (the oblong hole in the alternative embodiment shown) in this plate, into the rigid ring 24 to which the first end 17 of the spring is attached, and ultimately into a second hole in the wheel platform 8, the second hole being dimensioned such that the shaft 28 is forcibly inserted into this second hole whereas the first hole 34 is dimensioned such that the plate 30, and thus the drum-finger 10, is free to rotate about the shaft, and thus about the axis of rotation 22, with the head 27 ultimately being at least partially stacked on the plate, on the side opposite the spring, so as to ensure that this plate is held in an axial position. According to an optional additional feature, the central rigid ring 24 has a third hole which is dimensioned such that the shaft is also forcibly inserted into this third hole to rigidly attach the first end of the spring to the wheel platform. It should be noted that in another alternative embodiment, the rigid ring has an internal projection which is inserted into a corresponding cavity in the shaft of the hub. Thus, the rigid ring and the spring, more particularly its first end 17, are attached to the wheel platform 8 for rotation therewith, without however being attached thereto via the shaft.

In an advantageous alternative implementation of the coupling method according to the invention, the initial step of the particular alternative implementation described above is different in that firstly the hub, placed in a fitting, is provided and then the drum-finger is added by inserting the shaft of the hub into the oblong hole in this drum-finger, then the spring with its rigid ring and the coupling member are added and this assembly is positioned such that the hole in the rigid ring is positioned with an end part of the shaft of smaller diameter passing therethrough, this rigid ring thus being held temporarily above the interior space 9 of the drum-finger. The wheel platform is then added and positioned with the end part of the shaft also inserted into or aligned with its central hole. Finally, the rigid ring and the wheel platform are forcibly driven onto the shaft, leaving the drum-finger free to rotate. The device according to the invention is thus in said intermediate state.

The present invention relates to the advantageous coupling method for coupling a resilient element with a rigid element of a device of the horological movement, which method is described above, as well as to a horological movement comprising such a device and arranged in such a way as to allow the coupling method according to the invention to be implemented.

Thus, according to the invention, a general embodiment of a horological movement according to the invention comprises a device formed by a support, a rigid element which is movable and a resilient element which is coupled to this rigid element, the resilient element comprising a first end which is arranged so as to move with the support, at least in a first direction, and a second end carrying a coupling member inserted at least partially in a specific recess made in the rigid element. The support, the rigid element and the resilient element are arranged in such a way that, when the device is formed, they can be pre-mounted in the horological movement or pre-assembled in an intermediate state wherein:—the first end of the resilient element is arranged so as to move with the support in the first direction;—the rigid element and the support with the resilient element have an initial relative position, from among a range of possible relative positions, in which the resilient element is relaxed; and—the coupling member is located outside of its specific recess. The rigid element comprises a stressing ramp provided for the resilient element and located close to the specific recess, the stressing ramp being arranged so that, at least when assembling or mounting the device inside the horological movement from said intermediate state, the coupling member can come to bear against the stressing ramp, by a guided relative movement between the rigid element and the support in the first direction, from said initial relative position and then follow this stressing ramp as it approaches its specific recess while the relative movement is continued with at least one non-zero component in the first direction, the stressing ramp being arranged so that, during this continuation of the relative movement, the coupling member is displaced relative to the support, at least one non-zero component of which lies in a second direction that is not parallel to the first direction, and the resilient element is thus stressed. The coupling member is configured so that, after following the stressing ramp as it approaches its specific recess, it can penetrate at least partially into this recess, while the resilient element undergoes at least partial relaxation, and ultimately occupy a functional coupling position in which it remains during any normal operation of the horological movement.

According to a particular alternative embodiment, the spring 16, the coupling member 20 and the stressing ramp 40 are arranged so that the coupling member can, after following the stressing ramp as it moves towards its specific recess, slide over an end zone of the stressing ramp, while said relative movement is continued, before the coupling member reaches said functional coupling position in said specific recess.

According to a main alternative embodiment, the first direction is an angular direction relative to an axis of rotation, defining a rotation about this axis, and the second direction is a radial direction, relative to said axis of rotation, which passes through a geometric centre of the coupling member.

In a general alternative embodiment, said range of possible relative positions in said intermediate state extends over at least 20°. In an advantageous alternative embodiment, said range of possible relative positions in said intermediate state extends over at least 45°, preferably over at least 60°.

According to the first embodiment and the second embodiment described below, the device is a mechanism 6 for driving a jumping indicator 4, the resilient element being a spring 16 comprising a coil 18 between its first end 17 and its second end 19, said support being a wheel platform 8 which drives the first end of the spring and which defines said axis of rotation (the axis of rotation 22), the rigid element (drum-finger or lever) comprising a driving finger 12 arranged so as to be able periodically to drive the jumping indicator in a given drive direction 50.

According to a preferred alternative embodiment of the horological movement described above, the stressing ramp 40, the spring 16 and the coupling member 20 are arranged in such a way that, when the coupling member follows the stressing ramp as it approaches the specific recess 36, the coupling member can rotate about itself, which encourages or allows subsequent penetration of this coupling member into said specific recess, so that the coupling member can ultimately reach said functional coupling position.

According to the first embodiment, in the horological movement 2, the rigid element 10 is formed by a plate 30 which extends above the spring, on the side opposite the wheel platform 8, and by an axial wall 32 arranged at the edge of the plate and which slopes down towards the wheel platform, at least part of the axial wall and part of the plate which is stacked thereon jointly forming the driving finger 12. The plate has an oblong hole and is guided rotatably about the axis of rotation 22, relative to the wheel platform, by a shaft 28 attached to this wheel platform and passing through the oblong hole. The axial wall 32 defines the recess 36, which has a lateral opening on the spring side (i.e. on the side of the axis of rotation 22), the coupling member 20 being configured so as to be able to penetrate the specific recess 36 at least partially through the lateral opening, to ultimately reach said functional coupling position in which it remains during any normal operation of the horological movement, and to then allow the spring 16 to apply a driving force couple to the rigid element 10 and thus to the driving finger 12 in order to drive the jumping indicator 4.

According to an advantageous alternative embodiment, the coupling member has, in a general plane of the spring, a first shape and the recess has, in this general plane, a second shape, a dimension of said lateral opening not allowing the coupling member to leave the specific recess if it only undergoes at least one translation.

According to the advantageous alternative embodiment shown of the mechanism 6 of the horological movement according to the first embodiment, the stressing ramp 40 is arranged upstream of the recess 36 relative to a direction of rotation 56 of the wheel platform 8 when the jumping indicator 4 is driven by the mechanism 6 in the given drive direction 50, so that said relative movement between the rigid element 10 and the wheel platform in the angular direction D1 takes place for the wheel platform in said direction of rotation thereof.

According to a preferred alternative embodiment, the mechanism 6 is arranged in such a way that, if the coupling member 20 happens to come out of the specific recess 36 in the event of an impact or if the horological movement 2 is subjected to a certain high acceleration, this coupling member 20 can only occupy a pre-coupling position upstream of the specific recess 36 relative to the direction of rotation 56 of the wheel platform 8 when the jumping indicator 4 is driven by the mechanism in said given drive direction 56. The mechanism is arranged so that the coupling member can return to said functional coupling position when the wheel platform 8 is rotated by the horological movement in said direction of rotation 56 of this wheel platform, while the driving finger is bearing against a tooth on the jumping indicator. This preferred alternative embodiment is remarkable because, in the event of a specific impact that would cause the coupling member 20 to leave the specific recess 36, this coupling member can only be located upstream of the specific recess, and in the alternative embodiment shown with the upstream stressing ramp, also upstream of this ramp or optionally bearing against this ramp. This state corresponds to a situation of the automatic pre-coupling of the spring 16 and the rigid element 10 (drum-finger), because the rotation of the wheel platform 8, during normal operation of the horological movement, will generate, as soon as the driving finger 12 comes to bear against a tooth 5a of the indicator 4, a re-coupling process similar to that occurring in the coupling method of the invention. The coupling member 20 again climbs the stressing ramp 40, slides on the end zone of this ramp and optionally undergoes a certain rotation about itself (if provided for in the coupling method) and again enters the specific recess to ultimately occupy the intended coupling position before the spring is fully loaded, i.e. before the next jump that the indicator is intended to make. Thus, the fact that the coupling member 20 has come out of its specific recess, once the horological movement 2 has been assembled, has no negative repercussions on the driving of the indicator 4 by the mechanism, as the indicator does not miss any jumps and re-coupling takes place automatically.

A second embodiment of a horological movement according to the invention will now be described. Elements or references already described above will not be described again in detail.

The horological movement 62 according to the second embodiment is characterised firstly by the fact that the rigid element of the mechanism 60 is a lever 66 which is mounted on a plate 11 comprised by the mechanism. The plate 11 has a circular central hole 34A and is guided rotatably, about the axis of rotation 22 which is a first axis of rotation, relative to the wheel platform 8, by the shaft 28 to which this wheel platform is attached. The lever 66 is mounted on the plate 11 so as to be rotatable about a second axis of rotation 72 which is distant from the first axis of rotation 22, the second axis of rotation being arranged at a first end of the lever. More particularly, the lever is formed by an arm 67 comprising, at its first end, a stud 74, inserted in a corresponding hole in the plate 11 so as to be able to pivot about the second axis of rotation 72, and comprising, on the side of its second end, a driving finger 68 and an inner part defining a specific recess 76 for a coupling member 70 and comprising a front part 78 which defines a stressing ramp 80 for the spring 16A (which elements will be described in more detail below). The mechanism 60 further comprises a stop 90 which is integral with the plate 11 and which limits the rotation of the lever 66 in a first direction of rotation corresponding to a radial movement of the driving finger away from the first axis of rotation 22.

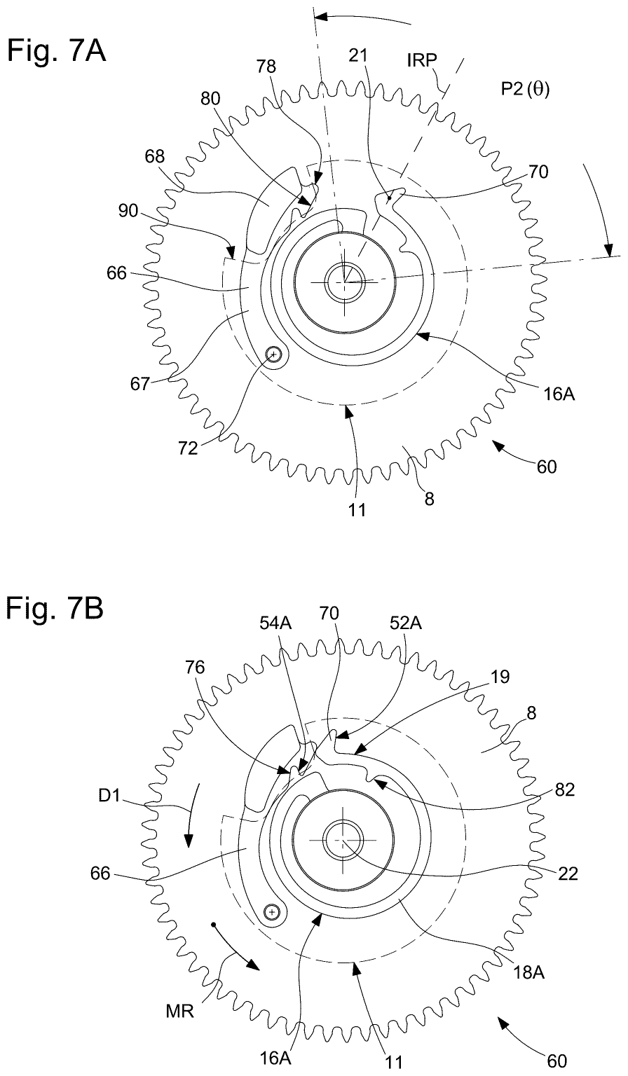

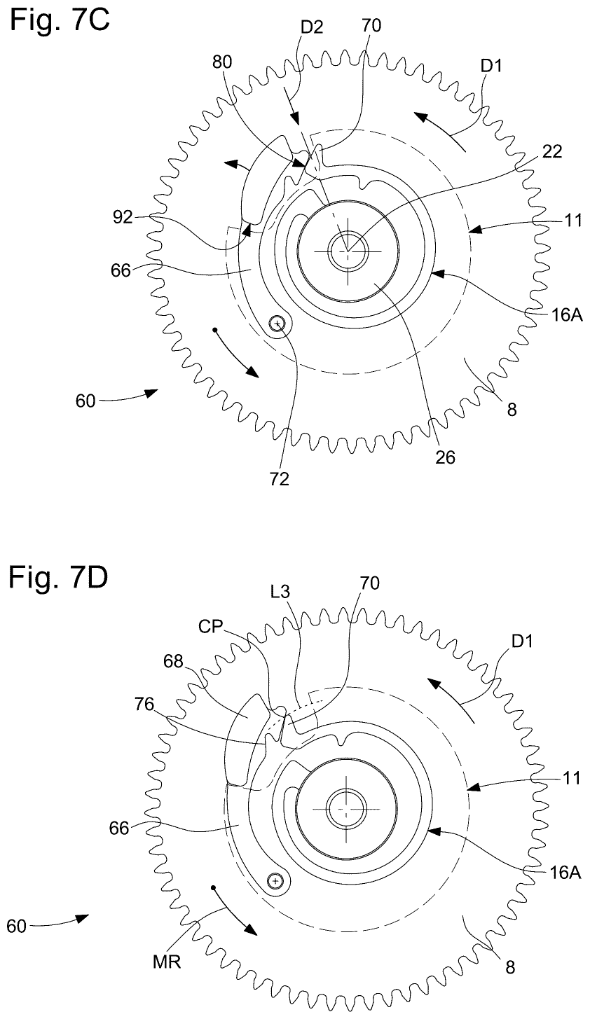

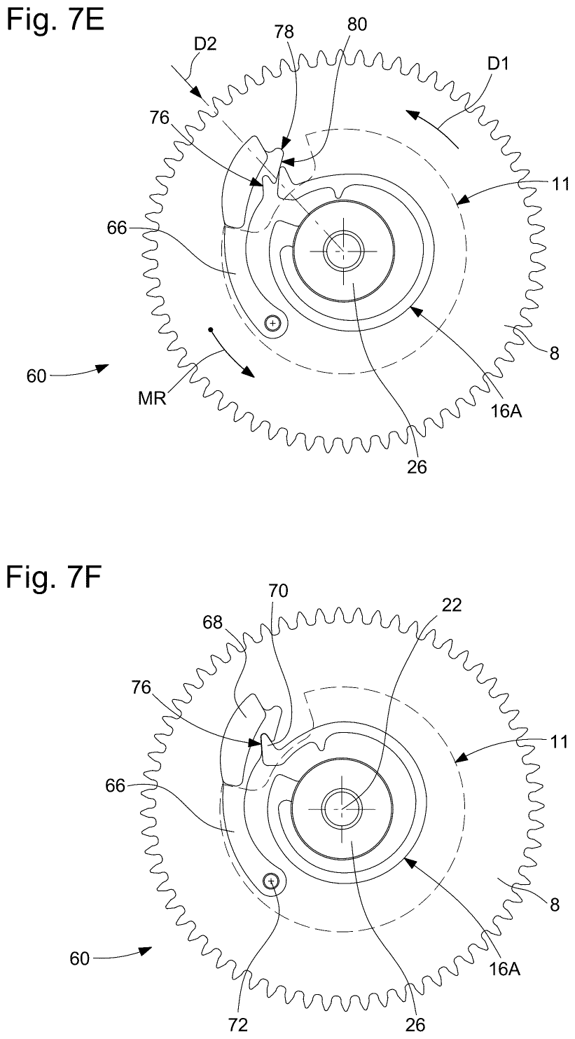

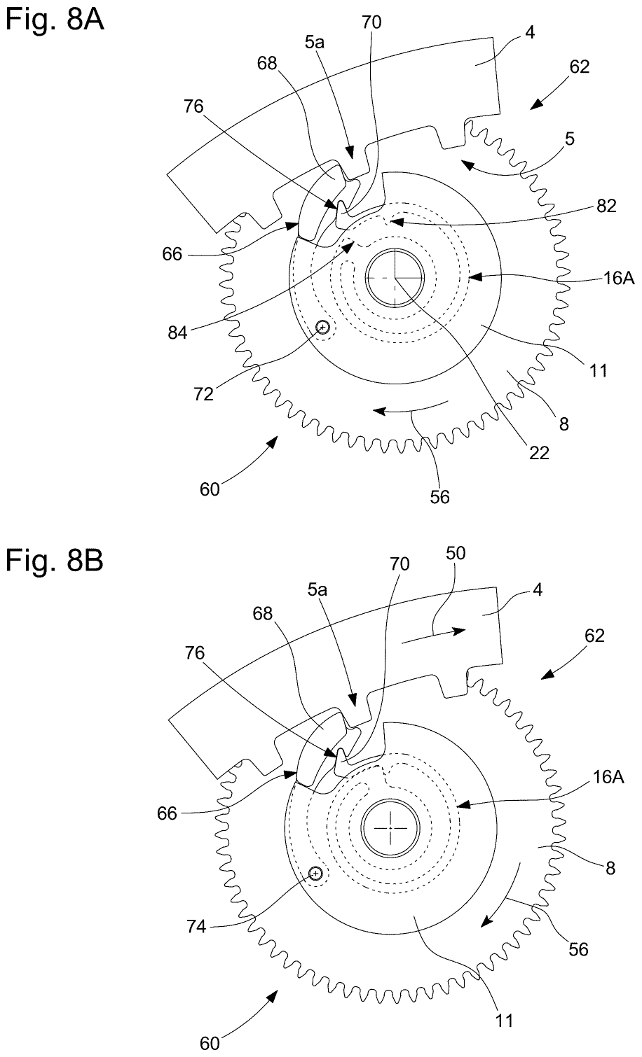

In the alternative embodiment shown, the plate 11 has a lateral surface, one zone of which defines the stop 90, the driving finger 68 being arranged so that a rear upper portion 92 of this finger can come to bear against the stop 90, so as to be held in a fixed angular position relative to the second axis of rotation and thus in a fixed position relative to the first axis of rotation, in particular when the indicator 4 is driven (FIG. 8B) or, in the context of the present invention, when the coupling member 70 follows said at least one end section of the stressing ramp 80 (FIG. 7D and 7E), as will be explained below.

Typically speaking, the stressing ramp 80 is arranged in such a way that, when the coupling member 70 follows this stressing ramp as it approaches the specific recess 76, the coupling member exerts a force couple on the lever 66 in the first direction of rotation and the coupling member 70 undergoes, at least on an end section of the stressing ramp, a radial displacement in a radial direction D2 towards the first axis of rotation 22, while the lever bears against the stop 90 and the spring 16A is stressed. Once again, the first end 17 of the spring 16A is connected to a central rigid ring 24A, whereas the second end 19 carries the coupling member 70. Between these two ends, the spring comprises a coil 18A which has, on the side of the second end, an internal projection 82, which is intended to stop the contraction of the spring, i.e. of its coil 18A, when the mechanism 60 is mounted in the horological movement 62 and is in operation, as shown in FIG. 8A and 8B, which are similar to FIG. 4A and 4B relating to the first embodiment. These FIG. 8A and 8B show the mechanism 60 and the date ring 4, comprising a toothing 5, when this ring is driven in order to change to a next date at midnight, respectively:—At the time when the driving finger 68 comes into contact with a tooth 5a of the ring and when the spring 16A is substantially angularly relaxed (i.e. not angularly stressed);—When the loading of the spring 16A ends, when the internal projection 82 of the spring comes to bear against the angular stop 84, the latter being arranged following the first end 17 of the spring, between this first end and the rigid ring 24A.

The plate 11 and the lever 66 are arranged in such a way that the lever can undergo, from a first position in which the lever 66 bears against the stop 90, a rotation in the second direction of rotation, which is opposite to the first direction of rotation, to reach a second position in which the driving finger 68 is retracted/withdrawn on the side of the first axis of rotation 22. The stressing ramp 80 is configured in such a way that, during the relative movement MR between the lever and the wheel platform 8 when the spring 16A is relaxed/unstressed and the lever is located in the second position, the coupling member 70 can come to bear against the stressing ramp 80 (FIG. 7B) and then be able to follow this stressing ramp as it approaches the specific recess 76 (FIG. 7C to 7E). In such a case, on a first section of the stressing ramp, during the relative movement MR, the coupling member 70 exerts a force on the second end of the lever which causes this lever to rotate in the first direction of rotation (FIG. 7C) until the lever comes to bear against the stop 90 (FIG. 7D).

FIG. 7D shows the contact point CP and the geometric line L3 involved in the coupling method, since it is at least necessary, according to the invention, for the spring 16A with the coupling member 70 and the lever 66 to be configured so that the stressing ramp 80 crosses the geometric line L3, passing through the contact point CP of the coupling member 70 and defining a circle around the central axis of rotation 22, in the situation shown in FIG. 7D where the lever is in contact with the stop 90 and the spring 16A is relaxed. More specifically, in a general alternative embodiment of the coupling method for the device comprising a lever 66, a step of positioning the lever can take place before the coupling step, this positioning step consisting of bringing the lever into contact with the stop 90, i.e. in its first position, before the relative movement MR between the wheel platform 8 and the plate 11. It should be noted that, in the alternative embodiment described here, the coupling member 70 undergoes a movement relative to the support, referred to as a relative movement, in the second direction D2 towards the axis of rotation 22 and the spring 16A is stressed only when the coupling member 70 continues to follow/climb the stressing ramp on a second section, located following the first section on the recess 76 side (FIG. 7E), after the lever 66 has come to bear against the stop 90 (FIG. 7D). Finally, the coupling member 70 enters its specific recess 76 through its lateral opening, while the spring undergoes rapid partial relaxation, and said relative movement is terminated by a small recoil, in the opposite direction to the direction of movement when the coupling member climbs the stressing ramp, to allow this member to reach the intended coupling position (FIG. 7F). In this functional coupling position, the spring can still be slightly radially stressed or radially relaxed. In the absence of any moment of force being exerted on the coupling member, the spring is thus, in this case, completely relaxed.

In this second embodiment, it can be seen that the relative movement MR between the wheel platform 8 (the support) and the lever 66 (the rigid element) can comprise three phases when the lever is not initially bearing against the stop 90. This relative movement comprises a first phase, which ends when the coupling member 70 comes into contact with the stressing ramp 80, during which phase the relative movement takes place in the angular direction D1, i.e. it is a rotation about the axis 22, guided by the shaft 28 of the hub 26 (it should be noted that the lever is considered here to not rotate about its own axis 72). Then, as indicated, the relative movement is continued until the coupling member is inserted into the specific recess 76. Thus, in a second phase of the relative movement MR, this relative movement is more complex as the lever gradually rotates about its own axis 72 until it comes to bear against the stop 90. In this second phase, the relative movement MR continues to have a component in said angular direction D1, i.e. a guided rotation about the central axis 22, which is necessary; however, a component also appears for the rotation of the lever 66 about its axis 72. This second phase will also be referred to as the “initial phase”, which is indeed an initial phase in relation to the fact that the coupling member follows/climbs the stressing ramp.

Then, once the lever has come to bear against the stop 90, its rotation about the axis 72 comes to an end and the third phase of the relative movement begins, which once again becomes a rotation about the central axis. It is during this third phase that the spring is radially stressed and the coupling member 70 undergoes a radial movement relative to the wheel platform, i.e. towards the axis of rotation 22 of this wheel platform. It should be noted that the appearance of a radial stress on the spring resulting from a radial displacement of the coupling member does not exclude any angular stress associated with an angular displacement of the coupling member relative to the wheel platform. To be precise, it can be mentioned that the stressing ramp is arranged such that, during said continuation of the relative movement, the coupling member undergoes a displacement relative to the support (the wheel platform 8), at least one non-zero component whereof lies in a second direction (D2) not parallel to the first direction (D1), and the resilient element (the spring 16) is thus stressed. To cover, in a general and precise manner, relative movements that can be complex, as is the case here, it can be mentioned that the stressing ramp is arranged in such a way that, at least during assembly of the device or mounting of the device in the horological movement from the intermediate state defined above, the coupling member can come to bear against the stressing ramp, by way of a guided relative movement between the rigid element and the support in the first direction (D1), from said initial relative position (IRP) and then follow this stressing ramp as it approaches the specific recess while the relative movement is continued with at least one non-zero component in the first direction.

The coupling member 70 is configured so as to be able to penetrate at least partially into its specific recess 76 through the lateral opening of this recess. In particular, the recess has a lateral surface 54A oriented obliquely in the direction of rotation 56 of the wheel platform 8, in which direction the indicator 4 is intended to be driven, relative to a radial direction passing through the centre of this lateral surface, and the coupling member 70 has a lateral flank 52A located facing the lateral surface 54A in the functional coupling position (see FIG. 7B and 7F), which is also inclined obliquely in the same direction as the lateral surface and which bears at least partially against this lateral surface at least when the indicator is driven (see FIG. 8B). This particular feature ensures that the coupling member is held securely in the specific recess as soon as the spring 16A is contracted. Moreover, the lateral surface 54A and the lateral flank 52A are relatively long.

The recess 76 is typically triangular in shape and opens out progressively towards its lateral opening. The shape of the part of the coupling member 70 which is inserted into the specific recess through the lateral opening corresponds substantially to that of the recess. This configuration advantageously allows the coupling member to be inserted easily into the specific recess, but would a priori allow this member to come out quite easily in the event of an impact, even though the recess is intended to be relatively deep. However, the spring 16A is arranged so that when this spring is loaded, the coupling member 70 is at a short distance from the inner end 17 of the spring which is rigidly connected to the central part 24A. In this situation, the coupling member 70 cannot come out of the specific recess in the event of an impact. Furthermore, when the driving finger does not interact with the toothing 5 of the indicator and the spring 16A is substantially relaxed, the coupling member 70 also cannot escape laterally from its specific recess in the event of an impact. The mechanism 60 is thus arranged so that, when the spring is relaxed or stressed during loading of this spring prior to the indicator jumping, the coupling member cannot move out of the specific recess 76.

Once inserted in its specific recess 76, the coupling member 70 is advantageously held in the specific recess by a radial force of the spring 16A applied to the coupling member in an outwards direction. This radial force is increased during a rapid change of the date or during a counter-clockwise time correction passing through midnight, by the fact that the driving finger 68 and the coupling member 70 are then retracted/withdrawn in the direction of the axis of rotation 22 via a clockwise rotation of the lever (second direction of rotation of the lever), such that the coupling member is thus normally held in the specific recess even when the spring 16A is somewhat expanded in such a situation. More specifically, given that the plate 11 rotates relative to the wheel platform 8, as is the case during the coupling method, namely in a direction opposite to the relative direction of rotation of this plate when the date ring 4 is driven by the mechanism 60, the coupling member 70 could theoretically come out of the specific recess 76. However, when such corrections are made, the driving finger and the coupling member move back towards the central axis, unlike during the coupling method.

When the driving finger 68 retracts, by a rotation of the lever 66 in said second direction towards the axis of rotation 22, during a rapid counter-clockwise correction of the date or time, the coupling finger 68 moves closer to the central part 24A so that, after a certain initial rotation of the lever, it can no longer come out of the specific recess 76. During the initial rotation, the spring 16A can undergo a certain angular stress causing it to expand and theoretically allowing the coupling member to come out of its specific recess in the event of an impact. However, if the coupling member undergoes an acceleration substantially in the direction of the axis of rotation 22 of the wheel platform 8, the lever is then subjected to a certain force couple, which generates a rotation of this lever about its axis of rotation 72, and the driving finger then follows the coupling member so that the latter remains at least partially inside its specific recess. If the acceleration takes place in a direction passing substantially through the centre of gravity of the lever and its axis of rotation 72, the coupling member 70 can undergo a movement causing it to come out of the specific recess 76. However, the internal projection 82 of the spring can be configured in such a way as to prevent the coupling member from coming completely out of its specific recess. In conclusion, the mechanism 60 is arranged so that the coupling member 70 remains in its specific recess 76 during normal operation, so that this coupling member is at all times integral with the driving finger during normal operation, and so that in most cases it cannot come out of its specific recess during impacts, preferably not at all.

The second embodiment is further distinguished from the first embodiment by the fact that the stressing ramp 80 is arranged downstream of the recess 76 relative to a direction of rotation 56 of the wheel platform 8 when the jumping indicator 4 is driven by the mechanism 60 in the given drive direction 50, so that said relative movement MR between the lever 66 and the wheel platform with the spring 16 takes place for the wheel platform in a direction opposite to its direction of rotation 56 when the jumping indicator 4 is driven. This second embodiment corresponds to a second implementation of the coupling method according to the invention, wherein the relative movement MR between the lever 66 and the wheel platform 8 takes place, for the wheel platform, in a direction opposite to the direction of rotation 56 of this wheel platform when the jumping indicator is driven by the mechanism in the given drive direction 50, and wherein the spring 16A is expanded during the coupling method. This second implementation of the method is shown in FIG. 7A to 7F, which have already been described. In FIG. 7A, the spring 16A, the wheel platform 8 and the lever 66, together with the plate 11 on which this lever is mounted, are in an initial relative position IRP within a range of possible relative positions P2(θ) for this initial relative position IRP, which here extends over approximately 90°. In other alternative embodiments, the range extends only over approximately 20° or 30°. Thus, in a general alternative embodiment, this range extends over at least 20°. In an advantageous alternative embodiment, the range of possible relative positions extends over at least 45°, preferably over at least 60°. It should be noted that, in the example shown, the lever 66 is initially in its second position, retracting/withdrawing towards the axis of rotation 22. The assembly of the various elements with a hub 26 takes place in a similar way to that described for the first implementation.

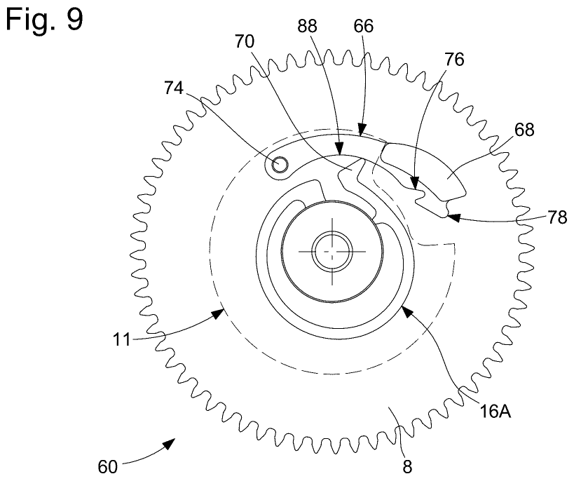

Advantageously, the mechanism 60 is arranged so that if, during the mounting of this mechanism, the coupling member 70 is ultimately located beyond its specific recess 76 because of a relative movement over too long a distance (situation shown in FIG. 9), this coupling member can momentarily occupy a pre-coupling position, upstream of its specific recess 76 relative to the direction of rotation 56 of the wheel platform 8 when the indicator 4 is driven. The mechanism 60 is arranged in such a way that the coupling member can move to the functional coupling position (FIG. 8A) from the pre-coupling position when the wheel platform 8 is driven in said direction of rotation 56 while the driving finger 68 is bearing against a tooth 5a on the jumping indicator 4. If the device 60 is inadvertently mounted in the horological movement 62 in the state shown in FIG. 9, i.e. with the coupling member in a pre-coupling position, as soon as the driving finger 68 comes to bear against a tooth 5a of the indicator during normal operation of the horological movement, the coupling member 70 follows the inner flank 88 of the lever 66 and the coupling member automatically reaches its specific recess 76 and adopts the intended coupling position. The spring 16A can then be contracted as intended to allow the indicator 4 to be driven by jumping. It goes without saying that, in such a case, testing the operation of mechanism 60 will require changing the position of the minute hand on its axis, if this hand has already been mounted before this test, in order to cause the indicator to jump.

1. A horological movement comprising a device formed by a support, a rigid element which is movable and a resilient element which is coupled to said rigid element, the resilient element comprising a first end which is arranged so as to move with the support, at least in a first direction (D1), and a second end carrying a coupling member inserted at least partially in a specific recess made in the rigid element; wherein the support, the rigid element and the resilient element are arranged in such a way that, when the device is formed, they can be pre-mounted in the horological movement or pre-assembled in an intermediate state wherein:
the first end of the resilient element is arranged so as to move with the support in the first direction (D1),
the rigid element and the support with the resilient element have an initial relative position (IRP), from among a range of possible relative positions (P1(θ), P2(θ)), wherein the resilient element is relaxed, and
the coupling member is located outside of said specific recess;
wherein the rigid element comprises a stressing ramp provided for the resilient element and located close to said specific recess, the stressing ramp being arranged so that, at least when assembling or mounting the device inside the horological movement from said intermediate state, the coupling member can come to bear against the stressing ramp, by a guided relative movement (MR) between the rigid element and the support in the first direction (D1), from said initial relative position and then follow said stressing ramp as it approaches its specific recess while the relative movement is continued with at least one non-zero component in the first direction, the stressing ramp being arranged so that, during said continuation of the relative movement, the coupling member is displaced relative to the support, at least one non-zero component of which lies in a second direction (D2) that is not parallel to the first direction (D1), and the resilient element is thus stressed; and wherein the coupling member is configured so that, after following the stressing ramp as it approaches said specific recess, it can penetrate at least partially into said recess, while the resilient element undergoes at least partial relaxation, and ultimately occupy a functional coupling position in which the coupling member remains during any normal operation of the horological movement.

2. The horological movement according to claim 1, wherein the spring, the coupling member and the stressing ramp are arranged so that the coupling member can, after following the stressing ramp as it moves towards its specific recess, slide over an end zone of said stressing ramp, while said relative movement is continued, before the coupling member reaches said functional coupling position in its specific recess.

3. The horological movement according to claim 1, wherein said coupling member is rigid.

4. The horological movement according to claim 1, wherein said first direction (D1) is an angular direction relative to an axis of rotation, defining a rotation about said axis, and said second direction (D2) is a radial direction, relative to said axis of rotation, which passes through a geometric centre of the coupling member.

5. The horological movement according to claim 4, wherein said range of possible relative positions (P1(θ), P2(θ)) in said intermediate state is an angular range which extends over at least 20°.

6. The horological movement according to claim 4, wherein said range of possible relative positions (P1(θ), P2(θ)) in said intermediate state is an angular range which extends over at least 60°.

7. The horological movement according to claim 4, wherein said device is a mechanism for driving a jumping indicator, the resilient element being a spring comprising a coil between its first end and its second end, said support being a wheel platform which is rotatably mounted about said axis of rotation and which drives the first end of the spring, the rigid element comprising a driving finger arranged to be able to periodically drive the jumping indicator in a given drive direction.

8. The horological movement according to claim 7, wherein the stressing ramp is arranged so that, when the coupling member follows this said stressing ramp as it approaches said specific recess, the coupling member is displaced radially towards the axis of rotation, and the coil of the spring is thus stressed.

9. The horological movement according to claim 8, wherein the stressing ramp, the spring and the coupling member are arranged in such a way that, when the coupling member follows the stressing ramp as it approaches said specific recess, the coupling member can rotate about itself, which encourages or allows subsequent penetration of said coupling member into the specific recess, so that the coupling member can ultimately reach said functional coupling position.

10. The horological movement according to claim 7, wherein the rigid element is formed by a plate which extends above the spring, on the side opposite the wheel platform, and by an axial wall arranged at the edge of the plate and which slopes down towards the wheel platform, at least part of the axial wall and part of the plate which is stacked thereon jointly forming the driving finger, the plate having an oblong hole and being guided rotatably about said axis of rotation, relative to the wheel platform, by a shaft attached to said wheel platform and passing through the oblong hole; and wherein the axial wall defines said specific recess, which has a lateral opening on the spring side, the coupling member being configured so as to be able to penetrate the specific recess at least partially through the lateral opening, to ultimately reach said functional coupling position, and to then allow the spring to apply a driving force couple to the rigid element and thus to the driving finger in order to drive the jumping indicator.

11. The horological movement according to claim 10, wherein said coupling member has, in a general plane of the spring, a first shape and the specific recess has, in said general plane, a second shape, a dimension of said lateral opening not allowing the coupling member to leave the specific recess if it only undergoes at least one translation.

12. The horological movement according to claim 7, wherein the stressing ramp is arranged upstream of the specific recess relative to a direction of rotation of the wheel platform when the jumping indicator is driven by the mechanism in said given drive direction, so that said relative movement (MR) between the rigid element and the wheel platform about said axis of rotation takes place, for the wheel platform, in said direction of rotation thereof.

13. The horological movement according to claim 7, wherein the rigid element is a lever which is mounted on a plate comprised by said mechanism, the plate being guided rotatably, about said axis of rotation which is a first axis of rotation, relative to the wheel platform, by a shaft to which said wheel platform is attached, the lever being mounted on the plate so as to be rotatable about a second axis of rotation which is distant from the first axis of rotation, the second axis of rotation being arranged at a first end of the lever and said lever forming the driving finger on the side of its second end, the mechanism comprising a stop which is integral with the plate and which limits the rotation of the lever in a first direction of rotation corresponding to a radial movement of the driving finger away from the first axis of rotation, the stressing ramp being arranged in such a way that, when the coupling member follows said stressing ramp as it approaches the specific recess, the coupling member exerts a force couple on the lever in the first direction of rotation and the coupling member undergoes, at least on an end section of the stressing ramp, a radial displacement towards the first axis of rotation, while the lever bears against the stop and the spring is stressed.

14. The horological movement according to claim 13, wherein the plate has a lateral surface, one zone of which defines the stop, the driving finger being arranged so that a rear upper portion of said driving finger can come to bear against the stop when the coupling member follows said at least one end section of the stressing ramp, in such a way that it is thus held in a fixed angular position relative to the second axis of rotation and thus in a fixed position relative to the first axis of rotation.

15. The horological movement according to claim 13, wherein the plate and the lever are arranged in such a way that the lever can undergo, from a first position in which the lever bears against the stop, a rotation in the second direction of rotation, which is opposite to the first direction of rotation, to reach a second position in which the driving finger is retracted on the side of the first axis of rotation; and wherein the stressing ramp is configured in such a way that, during said relative movement between the lever and the wheel platform when the spring is unstressed and the lever is located in the second position, the coupling member can come to bear against the stressing ramp and then be able to follow said stressing ramp as it approaches the specific recess while generating, in an initial phase, a rotation of the lever until it comes to bear against the stop.

16. The horological movement according to claim 13, wherein the stressing ramp is arranged downstream of the specific recess relative to a direction of rotation of the wheel platform when the jumping indicator is driven by the mechanism in said given drive direction, so that said relative movement (MR) between the lever and the wheel platform takes place, for the wheel platform, in a direction opposite to said direction of rotation of said wheel platform.

17. The horological movement according to claim 16, wherein the mechanism is arranged so that if, during the mounting of the mechanism, the coupling member is ultimately located beyond the specific recess because of a relative movement over too long a distance, said coupling member can momentarily occupy a pre-coupling position, upstream of the specific recess relative to said direction of rotation of the wheel platform; and wherein the mechanism is arranged in such a way that the coupling member can move to the functional coupling position from the pre-coupling position when the wheel platform is driven in said direction of rotation while the driving finger is bearing against a tooth on the jumping indicator.

18. The horological movement according to claim 16, wherein the mechanism is arranged so that, when the spring is relaxed or stressed during loading of the spring prior to the indicator jumping in said drive direction, the coupling member cannot move out of the specific recess.

19. The horological movement according to claim 7, wherein the mechanism is arranged in such a way that, if the coupling member happens to come out of the specific recess in the event of an impact or if the horological movement is subjected to a certain acceleration, said coupling member can only occupy a pre-coupling position upstream of the specific recess relative to a direction of rotation of the wheel platform when the jumping indicator is driven by the mechanism in said given drive direction, the mechanism being arranged so that the coupling member can return to said functional coupling position when the wheel platform is rotated by the horological movement in said direction of rotation of said wheel platform, while the driving finger is bearing against a tooth on the jumping indicator.

20. A method for coupling a rigid element with a resilient element when assembling or mounting a device intended to form a horological movement, wherein the resilient element comprises a first end, intended to be assembled with a support comprised in the device or the horological movement, and a second end carrying a coupling member intended to be assembled with the rigid element in order to couple the rigid element with the resilient element, the rigid element having a specific recess for the coupling member and a stressing ramp intended to guide the resilient element while stressing it, during the coupling method, and situated close to the specific recess; the coupling method comprising the following steps of:
attaching the first end of the resilient element to the support so that it moves as one therewith in a first direction (D1);
positioning the support with the resilient element and the rigid element in an initial relative position (IRP), from among a range of possible relative positions (P1(θ), P2(θ)), in which possible relative positions the resilient element is relaxed, in which initial relative position the stressing ramp is located between the coupling member and said specific recess of the rigid element and from which the rigid element and the support can undergo, at least during assembly or mounting of the device, a relative movement (MR) in the first direction (D1); the resilient element with the coupling member and the rigid element being configured so that the stressing ramp crosses a geometric line (L3) passing through a contact point (CP) between the coupling member and the stressing ramp and parallel to the first direction;
and then comprises the following coupling step of:
applying a relative movement (MR) between the support and the rigid element in said first direction (D1) so that the coupling member comes to bear against the stressing ramp, the coupling member then following said stressing ramp while the relative movement is continued with at least one non-zero component in the first direction, the stressing ramp being configured so as to generate, during said continuation of the relative movement, a displacement of the coupling member relative to the support, having at least one non-zero component in a second direction (D2) that is not parallel to the first direction, while stressing the resilient element; the relative movement being continued until the coupling member penetrates at least partially into said specific recess, while the resilient element undergoes at least partial relaxation in the second direction (D2), and ultimately occupies a functional coupling position in which the coupling member remains during any normal operation of the horological movement; the coupling member and said specific recess being configured to allow the coupling member to reach said functional coupling position, during said at least partial relaxation of the resilient element, after having followed the stressing ramp.

21. A coupling method according to claim 20, wherein the spring, the coupling member and the stressing ramp are arranged so that, during the coupling step, the coupling member slides, after following the stressing ramp, on an end zone of said stressing ramp, during said relative movement (MR), before the coupling member reaches said functional coupling position in its specific recess.

22. The coupling method according to claim 20, wherein the stressing ramp, the spring and the coupling member are arranged in such a way that, when the coupling member follows the stressing ramp as it approaches said specific recess, the coupling member rotates about itself, which encourages or allows subsequent penetration of said coupling member into said specific recess, so that the coupling member can reach said functional coupling position.

23. The coupling method according to claim 20, wherein said first direction (D1) is an angular direction relative to an axis of rotation, defining a rotation about said axis, and said second direction (D2) is a radial direction relative to said axis of rotation, which passes through a geometric centre of the coupling member, which is thus radially displaced as it follows the stressing ramp as it approaches said specific recess.

24. The coupling method according to claim 23, wherein said device is a mechanism for driving a jumping indicator, the resilient element being a spring comprising a coil between its first end and its second end, said support being a wheel platform driving the first end of the spring and mounted rotatably about said axis of rotation, the rigid element comprising a driving finger for driving the jumping indicator in a given drive direction.

25. The coupling method according to claim 24, wherein the stressing ramp is arranged upstream of said specific recess relative to a direction of rotation of the wheel platform when the jumping indicator is driven by the mechanism in said given drive direction.

26. The coupling method according to claim 24, wherein the stressing ramp is arranged downstream of said specific recess relative to a direction of rotation of the wheel platform when the jumping indicator is driven by the mechanism in said given drive direction.

27. The coupling method according to claim 23, wherein said range of possible relative positions (P1(θ), P2(θ)) in said intermediate state is an angular range which extends over at least 20°.

28. The coupling method according to claim 23, wherein said range of possible relative positions (P1(θ), P2(θ)) in said intermediate state is an angular range which extends over at least 45°.

29. The coupling method according to claim 24, wherein the rigid element is formed by a plate or is mounted rotatably on a plate; wherein the method comprises, during the assembly of the device before the coupling step, an initial step in which a hub comprising a shaft and a head, the wheel platform, the spring provided at its first end with a central rigid part and the plate, respectively the plate with the rigid element mounted on said plate, are brought and positioned such that the wheel platform, the spring and the plate, respectively the rigid element, are in a relative position corresponding angularly to one said possible relative position with the spring located between the wheel platform and the plate, and the head located on a side opposite the spring relative to the plate; such that the shaft, a first hole in the plate, a second hole in the wheel platform and a third hole defined by the central rigid part are aligned on said axis of rotation, the second hole having a smaller diameter than the first hole and the head being at least partially stacked on the plate; and then an assembly step which includes said rigid attachment step and in which the shaft is forcibly inserted into the second hole in the wheel platform, leaving the plate free to rotate about the shaft, with the head ultimately ensuring that said plate is held in the axial position.

30. The coupling method according to claim 29, wherein said third hole is dimensioned such that the shaft is also forcibly inserted into said third hole during the assembly step in order to rigidly attach the first end of the spring with the wheel platform.
